(19) United States
(12) Patent Application Publication
(10) Pub. No.: US 2014/0267470 A1
(43) Pub. Date: Sep. 18, 2014

(54) COLOR ADJUSTMENT DEVICE, METHOD FOR ADJUSTING COLOR, AND DISPLAY

(71) Applicant: Chih-tsung Kang, Shenzhen (CN)

(72) Inventor: Chih-tsung Kang, Shenzhen (CN)

(73) Assignee: Shenzhen China Star Optoelectronics Technology Co. Ltd., Shenzhen (CN)

(21) Appl. No.: 13/379,664

(22) PCT Filed: Dec. 8, 2011
(86) PCT No.: PCT/CN11/83684

§ 371 Date: Dec. 21, 2011

(30) Foreign Application Priority Data
Dec. 7, 2011 (CN) 201110403089.2

(51) Int. Cl. G09G 3/20; G09G 3/36

(52) U.S. Cl. CPC G09G 3/2003; G09G 3/3607; G09G 2320/0666; G09G 2340/06
USPC 345/694; 345/690; 345/88

(57) ABSTRACT

The present invention proposes a color adjustment device, a method for adjusting color and a display, which first determines a set of three stimulus values displaying as white in the CIE 1931 XYZ color space, and then converts the tristimulus value into a luminance value and two chromaticity values based on the CIE 1976 L* a* b* color space, and determines a set of target luminance value and two target chromaticity values of each and every grayscale respectively according to the set of luminance value and two chromaticity values, and finally converts the set of target luminance value and two target chromaticity values of each and every grayscale into target stimulus sets in accordance with the CIE 1931 XYZ, each grayscale corresponds to a target set of stimulus values. By this way, the color values of whites of all grayscales belong to the same hue.

### BACKGROUND OF THE INVENTION

1. Field of the Invention

The present invention relates to a display, and more particularly to a color adjustment device, a method for adjusting color, and a display.

2. Description of the Prior Art

Based on a conventional image processing technology, a display area of a LCD panel is divided into multiple pixels, each of which comprises sub-pixels of displaying red, green and blue. Because all colors of visible light can be made by mixture of red, green and blue light, a required color shown in a pixel can be constructed by controlling lightness value of the red, green and blue sub-pixels.

To describe color more appropriately, the International Commission on Illumination, hereinafter referred to as the CIE, proposed the CIE 1931 XYZ color space, in which regard red, green and blue as three primary colors, and all other colors can be generated by mixture of the three primary colors. Two light sources, made up of different mixtures of various wavelengths, may appear to be the same color; this effect is called metamerism. Two light sources have the same apparent color to an observer when they have the same tristimulus values, no matter what spectral distributions of light were used to produce them. In this case, the two light sources have the same tristimulus values X, Y and Z which refer to proportions of the three primary colors. The CIE 1931 XYZ Space usually shows as the CIE 1931 chromaticity diagram, of which three parameters Y, x, y, where Y refers to luminance value, that is the stimulus value Y, while x and y refer to chromaticity values. x=X/(X+Y+Z), y=Y/(X+Y+Z), z=Z/(X+Y+Z). Because x+y+z=1, z can be expressed in x and y.

The CIE 1931 XYZ color space can not represent a uniform space of human's sight. As a result, CIE proposed a new CIE 1976 L*a*b* color space in order to further improve and unify the method of color valuation. The CIE 1976 L*a*b* color space can be obtained mathematically out of the CIE 1931 XYZ color space, wherein X, Y and Y are tristimulus values; L* refers to luminance; a* and b* represents hue. Generally speaking, the CIE 1976 L*a*b* color space is a more sensually linear color space than the CIE 1931 XYZ color space.

Due to factors of materials and process for a LCD panel, color performance of each LCD shows considerable difference. In order to attain certain correctness and unanimity of colors of the LCD, it is necessary to adjust the grayscale white balance for each LCD. The conventional method of adjusting the grayscale white balance is as followed: At first, make pixels of the LCD show as white in all grayscales, and then adjust gain value of the strength of red, green and blue so that the chromaticity value and luminance value of white performed in the LCD approaches a chromaticity value and luminance value of a target white, that is, the white performed in the LCD is adjusted within a certain range of color temperature and color derivation.

Referring to FIG. 1, FIG. 1 shows a graph of relation between white and chromaticity value in igrayscale n 0 to 255, according to the CIE 1931 XYZ color space, where Wxₙ and Wyₙ refer to the chromaticity value x, y required to perform as white in grayscale n (n=0, 1, 2, 3 . . . 254, 255). FIG. 1 shows that the chromaticity value x, y of various white in different grayscale in the CIE1931 color space. For instance, in the grayscale 50, when Wx₅₀=0.285 and Wy₅₀=0.295, the pixel performs as white. In other words, by adjusting the grayscale value applied to the sub-pixels RGB of the pixel so as to the chromaticity value of sub-pixels RGB meet Wx₅₀=0.285 and Wy₅₀=0.295, the pixel is performing as white. Take FIG. 1 for example, in higher grayscale, such as grayscale 40 to 255, the ratio of the chromaticity values x and y is a constant, that is, Wx₂₅₅=Wxₙ=0.285 and Wy₂₅₅=Wy₅₀=0.295, n=40, 41, . . . , 255, while in lower grayscale, such as 1 to 40, the ratios of the color values x and y are diverse.

Despite of it, the CIE 1931 XYZ color space is not a uniform space in human's sight, even under the condition that Wxₙ=Wx₂₅₅, Wyₙ=Wy₂₅₅, n=1, 2, . . . 255 in the coordinate system of the CIE 1931 color space, the whites perceived in different grayscale actually do not fall in the same hue. That is, there is a phenomenon of color cast among the whites perceived in the different grayscale. Namely, the whites perceived in some grayscale turn slightly bluish or reddish white. Referring to FIG. 2, FIG. 2 shows a graph of color alteration after the CIE 1931 XYZ color space converts into the CIE 1976 L*a*b* color space. Although FIG. 2 shows the color alteration in 2-dimension a* and b*, substantially, a* and b* include an effect of luminance value L* on human's sight. According to the definition of the CIE 1931 XYZ color space in FIG. 1, all whites of grayscales remain constant, but it is shown in FIG. 2 that the color values of all whites, after the conversion from the CIE 1931 XYZ color space into the CIE 1976 L*a*b* color space, denote as A, do not represent as a straight line through the origin, which means when the whites change along with all grayscales according to the CIE 1931 XYZ, all the whites do not perform as a uniform hue in human's sight. In FIG. 2, hue refers to h, where h=arc tan(b*/a*), while chroma refers to C, where C=\sqrt{(a*)²+(b*)²}. As a result, two colors in the same hue share the same ratio of a* to b*. The greater the chromaticity values a* and b* are, the greater the chroma is. Namely, it is only the straight line B through the origin in the coordinate system of a* and b* that represents all whites of grayscales belongs to the same hue.

As a consequence, it becomes an object of the industry to develop a color adjustment device, a method for adjusting color and a display for the same, achieving that all whites of grayscales are of the same hue after white balance.

### SUMMARY OF THE INVENTION

Accordingly, the present invention has been made to provide a device, method and display of color adjustment, which unifies all whites of grayscales belong to the same hue.

According to the present invention, a method for adjusting color comprises: measuring a set of tristimulus values performing as white at a first grayscale on a liquid crystal display (LCD) panel according to a first color space; converting the set of tristimulus values into a luminance value L*₂₅₅, a first chromaticity value a*₂₅₅ and a second chromaticity value b*₂₅₅ in accordance with a second color space; determining a target luminance value L*ₙ of each grayscale based on the formula: L*ₙ=L*₂₅₅×(n/255)^{2.2}, a target first chromaticity value a*ₙ of each grayscale based on the formula: a*ₙ₌(a*₂₅₅/255)×n, and a target second chromaticity value b*ₙ of each grayscale based on the formula: b*=(b*₂₅₅/255)×n, based on the luminance value L*₂₅₅, the first chromaticity value a*₂₅₅ and the second chromaticity value b*₂₅₅, where n=1, 2, . . . , 255; converting the luminance value, the first chromaticity value and the second chromaticity value of each grayscale into a plurality of sets of target values in accordance with the first color space, each grayscale corresponds to a set of target stimulus values and each set of target stimulus values comprises three target stimulus values; and determining a set of ratios of three primary colors corresponding to each set of the three target stimulus values.

In one aspect of the present invention, the method further comprises: adjusting a set of ratios of three primary colors of a predetermined grayscale based on the set of ratios of three primary colors out of the set of three target stimulus values corresponding to the predetermined grayscale, before the LCD panel showing the predetermined grayscale.

In another aspect of the present invention, the LCD panel comprises a plurality of pixels. Each pixel comprises a plurality of sub-pixels for displaying red, green, and blue. The method further comprises: adjust a driving voltage applied in the plurality of sub-pixels of each pixel according to the set of ratios of three primary colors of the set of three target stimulus values corresponding to the predetermined grayscale.

In yet another aspect of the present invention, the first color space accords with the CIE 1931 XYZ color space, and the second color space accords with the CIE 1976 L* a* b* color space.

According to the present invention, a color adjustment device comprises: a measuring unit for measuring a set of tristimulus values performing as white of the first grayscale according to the first color space on a LCD panel; a first conversion unit, coupled to the measuring unit, for converting the tristimulus values into a set of a luminance value L*₂₅₅, a first chromaticity value a*₂₅₅, and a second chromaticity value b*₂₅₅ on the basis of the second color space; a determining unit, coupled to the first conversion unit, for determining a target luminance value L*ₙ of each grayscale based on the formula: L*ₙ=L*₂₅₅×(n/255)^{2.2}, a target first chromaticity value a*ₙ of each grayscale based on the formula: a*ₙ=(a*₂₅₅/255)×n, and a target second chromaticity value b*ₙ of each grayscale based on the formula: b*ₙ=(b*₂₅₅/255)×n, where n=1, 2, . . . , 255; a second conversion unit, coupled to the determining unit, for converting the target luminance value, the target first chromaticity value, and the target second chromaticity value of each grayscale into a plurality of sets of target values in accordance with the first color space, where each grayscale corresponds to a set of target stimulus values, and each set of the target stimulus values comprises three target stimulus values; and a calculation unit, coupled to the second conversion unit, for calculating a set of ratios of three primary colors corresponding to the three stimulus values of each set of the target stimulus values.

In one aspect of the present invention, the color adjustment device further comprises: a storage unit for storing as a lookup table of the ratios of three primary colors corresponding to the three target stimulus values of each set of target stimulus values produced by the calculation unit.

In another aspect of the present invention, the color adjustment device further comprises: an adjusting unit, coupled to the storage unit, for adjusting a set of ratios of three primary colors of the predetermined grayscale according to the ratio of three primary colors of the set of three target stimulus values corresponding to the predetermined grayscale before the LCD panel displaying a predetermined grayscale.

In yet another aspect of the present invention, the first color space accords with the CIE 1931 XYZ color space, and the second color space accords with the CIE 1976 L* a* b* color space.

According to the present invention, a display comprises a liquid crystal display (LCD) panel and a color adjustment device. The LCD panel comprises a plurality of pixels for displaying an image. Each pixel comprises a plurality of sub-pixels. The color adjustment device comprises: a measuring unit for measuring a set of tristimulus values performing as white of the first grayscale according to the first color space on a LCD panel; a first conversion unit, coupled to the measuring unit, for converting the tristimulus values into a set of a luminance value L*₂₅₅, a first chromaticity value a*₂₅₅, and a second chromaticity value b*₂₅₅ on the basis of the second color space; a determining unit, coupled to the first conversion unit, for determining a target luminance value L*ₙ of each grayscale based on the formula: L*ₙ=L*₂₅₅×(n/255)^{2.2}, a target first chromaticity value a*ₙ of each grayscale based on the formula: a*ₙ=(a*₂₅₅/255)×n, and a target second chromaticity value b*ₙ of each grayscale based on the formula: b*ₙ=(b*₂₅₅/255)×n, where n=1, 2, . . . , 255; a second conversion unit, coupled to the determining unit, for converting the target luminance value, the target first chromaticity value, and the target second chromaticity value of each grayscale into a plurality of sets of target values in accordance with the first color space, where each grayscale corresponds to a set of target stimulus values, and each set of the target stimulus values comprises three target stimulus values; and a calculation unit, coupled to the second conversion unit, for calculating a set of ratios of three primary colors corresponding to the three stimulus values of each set of the target stimulus values.

In one aspect of the present invention, the color adjustment device further comprises a storage unit for storing as a lookup table of the ratios of three primary colors corresponding to the three target stimulus values of each set of target stimulus values produced by the calculation unit.

In another aspect of the present invention, the color adjustment device further comprises an adjusting unit, coupled to the storage unit, for adjusting a set of ratios of three primary colors of the predetermined grayscale according to the ratio of three primary colors of the set of three target stimulus values corresponding to the predetermined grayscale before the LCD panel displaying a predetermined grayscale.

In yet another aspect of the present invention, the display further comprises a driving unit coupled to the adjusting unit for adjusting driving voltage applied to the plurality of sub-pixels of each pixel according to the ratios of three primary colors corresponding to the set of three target stimulus values fitting to the predetermined grayscale.

In still another aspect of the present invention, the first color space accords with the CIE 1931 XYZ color space, and the second color space accords with the CIE 1976 L* a* b* color space.

In contrast to prior art, the color adjustment device, the method for adjusting color and the display according to the present invention first determines a set of tristimulus values performing as white in the CIE 1931 XYZ color space, and then converts the set of tristimulus values into a set of luminance value, first color value, second chromaticity value in accordance with the CIE 1976 L* a* b* color space. On the basis of the set of luminance value, first color value, second color value, a set of target luminance value, a target first chromaticity value and a target second chromaticity value of each grayscale are determined respectively. Finally, the set of target luminance value, first target chromaticity value and second target chromaticity value are converted into a plurality of sets of target stimulus values in accordance with the CIE 1931 XYZ color space, where each grayscale corresponds to one of the sets of target stimulus values. By this way, all whites of grayscales are of the same hue.

These and other features, aspects and advantages of the present disclosure will become understood with reference to the following description, appended claims and accompanying figures.

### BRIEF DESCRIPTION OF THE DRAWINGS

FIG. 1 shows a graph of relation between white and chromaticity value in igrayscale n 0 to 255.

FIG. 2 shows a graph of color alteration after the CIE 1931 XYZ color space converts into the CIE 1976 L*a*b* color space.

FIG. 3 shows a schematic diagram of a display according to a preferred embodiment of the present invention.

FIG. 4 shows a block diagram of a color adjustment device according to a preferred embodiment of the present invention.

FIG. 5 shows a flow chart of a method for adjusting color according to the present invention.

FIG. 6 shows a graph of chromaticity values in relationship to the whites corresponding to the grayscales 0-255 in the CIE 1931 XYZ color space, which are performed on the display.

### DETAILED DESCRIPTION OF THE PREFERRED EMBODIMENTS

Referring to FIG. 3, FIG. 3 shows a schematic diagram of a display 100 according to a preferred embodiment of the present invention. The display 100 can be a personal computer, a notebook computer, a digital camera, a digital camcorder, which comprises a LCD panel 110. The display 100 further comprises a timing controller 104, source drivers 106, gate drivers 108, and a color adjustment device 102. The LCD panel 110 comprises a plurality of pixels 130 arranged in a matrix. Each pixel 130 comprises at least of three sub-pixels 120 for displaying red, green, and blue (RGB). When a vertical sync signal, generated by the timing controller 104, transmitted to the gate driver 108, the gate driver 108 subsequently produces a scan pulse to the LCD panel 110, simultaneously, the timing controller 104 produces a horizontal sync signal to the source driver 106, and then the source driver 106 outputs a grayscale voltage signal to the sub-pixel 120 of the LCD panel 110. Each sub-pixel 120 comprises a pixel electrode 124 and a thin-film transistor 122. A gate, source and drain of the thin-film transistor 122 respectively electrically connects to the gate driver 108, the source driver 106 and the pixel electrode 124 of the corresponding sub-pixel 120. The gate of the thin-film transistor 122 is turned on upon receiving a scan pulse transmitted from the gate driver 108. At then, a data voltage from the source driver 106 is applied to the pixel electrode 124. Alignment of liquid crystal molecules is adjusted based on the data voltage applied on the pixel electrode 124, and thus the alignment of the liquid crystal molecules decides the light transmittance of the pixel electrode 124. Because each pixel 130 is composed of a plurality of ROB sub-pixels 120, a color performed by each pixel 130 is determined by a proportion of light transmittance of the plurality of RGB sub-pixels 120.

FIG. 4 shows a block diagram of a color adjustment device 102. The color adjustment device 102 comprises a measuring unit 140, a first conversion unit 141, a determining unit 144, a second conversion unit 142, a calculation unit 146, a storage unit 148 and an adjusting unit 150. The measuring unit 140 measures a set of tristimulus values performing as white in a first grayscale according to a first color space on the LCD panel 110. The first conversion unit 141, coupled to the measuring unit 140, converts the tristimulus values into a set of a luminance value L*₂₅₅, a first chromaticity value a*₂₅₅, and a second chromaticity value b*₂₅₅ on the basis of a second color space. The determining unit 144, coupled to the first conversion unit 141, determines a target luminance value L*ₙ of each grayscale based on the formula: L*ₙ=L*₂₅₅×(n/255)^{2.2}, a target first color value a*ₙ of each grayscale based on the formula: a*ₙ=(a*₂₅₅/255)×n, and a target second chromaticity value b*ₙ of each grayscale based on the formula: b*ₙ=(b*₂₅₅/255)×n, where n=1, 2, . . . , 255. The second conversion unit 142, coupled to the determining unit 144, converts the L*ₙ, a*ₙ and b*ₙ of each grayscale into a plurality of sets of target values in accordance with the first color space, where each grayscale corresponds to a set of three target stimulus values. The calculation unit 146, coupled to the second conversion unit 142, calculates a ratio of three primary colors corresponding to each set of the three target stimulus values. The storage unit 148 stores as a lookup table 152 of all the ratios of three primary colors corresponding to the sets of three target stimulus values produced by the calculation unit 146. The adjusting unit 150, coupled to the storage unit 148, before the LCD panel 110 showing a predetermined grayscale, the adjusting unit 150 adjusts the ratio of three primary colors of the predetermined grayscale based on the ratio of three primary colors out of the set of target stimulus values corresponding to the predetermined grayscale. After then, the ratio of the three primary colors is transmitted to the source driver 106.

Referring to FIG. 5, FIG. 5 shows a flow chart of a method for adjusting color according to the present invention. The method for adjusting color comprises following steps:

Step 400: In the first color space, measure a set of tristimulus values WX₂₅₅, WY₂₅₅, WZ₂₅₅ performing as white at the first grayscale (e.g. grayscale 255) on the LCD 110.

Step 402: Convert the set of WX₂₅₅, WY₂₅₅, WZ₂₅₅ into the luminance value L*₂₅₅, the first chromaticity value a*₂₅₅ and the second chromaticity value b*₂₅₅ in accordance with the second color space.

Step 404: Determine the target luminance value L*ₙ of each grayscale based on the formula: L*ₙ=L*₂₅₅×(n/255)^{2.2}, the target first chromaticity value a*ₙ of each grayscale based on the formula: a*ₙ=(a*₂₅₅/255)×n, and the target second chromaticity value b*ₙ of each grayscale based on the formula: b*ₙ=(b*₂₅₅/255)×n, where n=1, 2, . . . , 255.

Step 406: Convert the L*ₙ, a*ₙ and b*n of each grayscale into a plurality of sets of target values (NWXn, NWYn, NWZn) in accordance with the first color space, in which each grayscale corresponds to a set of target values, and each target values comprises three target stimulus values NWXn, NWYn, NWZn, where NWXn refers to the target stimulus value X of white at the grayscale n, NWYn to the target stimulus value Y of that, and NWZn to the target stimulus value Z of that.

Step 408: Calculate a ratio of three primary colors (RXₚ, GX_{q}, BXₛ), (RYₚ, GY_{q}, BYₛ) and (RZₚ, GZ_{q}, BZₛ) corresponding to the three target stimulus values NWXn, NWYn, NWZn of each set of target values, where NWXn=RXₚ+GX_{q}+BXₛ, NWYn=RYₚ+GY_{q}+BYₛ, NWZn=RZₚ+GZ_{q}+BZₛ, p, q, s=0, 1, 2, . . . , 255. RXₚ refers to a stimulus value X of red at the p grayscale, GX_{q} to a stimulus value X of green at the q grayscale, and BXₛ to a stimulus value X of blue at the s grayscale. So are the remaining parameters. Subsequently, integrate into a lookup table of all ratios of three primary colors (RXₚ, GX_{q}, BX_{S}), (RYₚ, GY_{q}, BYₛ) and (RZₚ, GZ_{q}, BZₛ) corresponding to each set of the three target stimulus values NWXn, NWYn, NWZn.

Step 410: Before the LCD panel 110 showing a predetermined grayscale, adjusting the ratio of three primary colors of the predetermined grayscale based on the ratio of three primary colors out of the set of target stimulus values corresponding to the predetermined grayscale.

Referring to FIG. 3 to FIG. 5, firstly, the all pixels 130 of the LCD panel 110 performs as white according to the original first grayscale (e.g. grayscale 255), and the measuring unit 140 measures an original set of ratios of three primary colors of the pixels of RGB 120 when it shows white at the first grayscale(255) and determines a set of tristimulus values WX₂₅₅, WY₂₅₅, WZ₂₅₅ based on the original set of ratios (Step 400). The tristimulus values WX₂₅₅, WY₂₅₅, WZ₂₅₅ are defined in the CIE 1931 XYZ color space. Second, the first conversion unit 141 converts the tristimulus values WX₂₅₅, WY₂₅₅, WZ₂₅₅ into the set of a luminance value L*₂₅₅, a first chromaticity value a*₂₅₅ and a second chromaticity value b*₂₅₅ complying with the second color space, i.e. CIE 1976 L*a*b* color space, by the following conversion equations (1) and (2) (Step 402).

L*=116f(Y/Yn)−16,a*=500[f(X/Xn)−f(Y/Yn)],b*=200[f(Y/Yn)−f(Z/Zn)]

Xn=Yn=Zn=100;

When X/Xn or Y/Yn or Z/Zn>0.008856,

f(X/Xn)=(X/Xn)^{1/3},f(Y/Yn)=(Y/Yn)^{1/3},f(Z/Zn)=(Z/Zn)^{1/3} Equation (1)

or when X/Xn or Y/Yn or Z/Zn≦0.008856,

f(X/Xn)=7.787×(X/Xn)+16/116, f(Y/Yn)=7.787×(Y/Yn)+16/116,

f(Z/Zn)=7.787×(Z/Zn)+16/116, Equation (2)

where X, Y and Z denote to tristimulus values, L* refers to a luminance value, a* and b* demote to chromaticity value.

According to above equations, the luminance value L*₂₅₅, the first chromaticity value a*₂₅₅ and the second chromaticity value b*₂₅₅ can be obtained by substituting X=WX₂₅₅, Y=WY₂₅₅, Z=WZ₂₅₅ in the above equations.

Referring to FIG. 2, a coordination of an endpoint D (\sqrt{(a₂₅₅)²+(b*₂₅₅)²}, arctan

$$( \frac{{b}_{255}^{*}}{{a}_{255}^{*}} ) )$$

represents respectively a saturation and a hue corresponding to the first chromaticity value a*₂₅₅ and the second chromaticity value b*₂₅₅of white at grayscale 255. The coordinate (0,0) of the origin O represents \sqrt{(a₀)²+(b₀)²}=0, and arctan

$$( \frac{{b}_{0}^{*}}{{a}_{0}^{*}} ) = 0 ,$$

which means the saturation of grayscale 0, a*₀, b*₀=0, that is black. From the endpoint D to the origin O, a straight line B is drawn. The proportion of a* to b* of each and every point on the line B is identical, that is, the coordination (a*, b*) of each point on the line B appears as the identical white hue.

On the basis of the line B in FIG. 2, the determining unit 144 determines the target first chromaticity value a*ₙ of each grayscale based on the formula: a*ₙ=(a₂₅₅/255)×n, and the target second chromaticity value b*ₙ of each grayscale based on the formula: b*ₙ (b*₂₅₅/255)×n, where n=1, 2, . . . , 255. Moreover, in the CIE 1976 L*a*b* color space, L*₀=0 refers to black and L*₂₅₅ to white. The determining unit 144 also determines the target luminance value L*ₙ of each grayscale based on the formula: L*ₙ=L*₂₅₅×(n/255)^{2.2}, n=1, 2, . . . , 255. As a result, the determining unit 144 produces 256 sets of (L*ₙ,a*ₙ,b*ₙ) according to 256 grayscales, where n=0, 2, . . . , 255.

Referring to FIG. 6, FIG. 6 shows a graph of chromaticity values in relationship to the whites corresponding to grayscales 0-255 in the CIE 1931 XYZ color space, which are performed in the display according to the present invention. At the step 406, the second conversion unit 142 converts the 256 sets of the target luminance value L*ₙ, the first target chromaticity value a*ₙ and the second chromaticity value b*ₙ into the 256 sets of three target stimulus values (NWXn, NWYn, NWZn) based on the CIE 1931 XYZ color space, in which each grayscale corresponds to a set of target values, and each target values comprises three target stimulus values NWXn, NWYn and NWZn. The conversion relationship of the first conversion unit 141 to the second conversion unit 142 is of inversion function. Differing from FIG. 1, the ratios of chromaticity value x and y at the total grayscales vary in FIG. 6.

At the step 408, the calculation unit 146 calculates the 256 sets of the ratios of three primary colors (RXₚ, GX_{q}, BXₛ), (RYₚ, GY_{q}, BYₛ) and (RZₚ, GZ_{q}, BZₛ) corresponding to the 256 sets of target stimulus values (NWXn, NWYn, NWZn), where NWXn=RXₚ+GX_{q}+BXₛ, NWYn=RYₚ+GY_{q}+BYₛ, NWZn=RZₚ+GZ_{q}+BZₛ, p, q, s=0, 1, 2, . . . , 255. RXₚ refers to a stimulus value X of red at the p grayscale, GX_{q} to a stimulus value X of green at the q grayscale, and BXₛ, to a stimulus value X of blue at the s grayscale. So are the remaining parameters. Subsequently, integrate into a lookup table 152 of all ratios of three primary colors (RXₚ, GX_{q}, BXₛ), (RYₚ, GY_{q}, BYₛ) and (RZₚ, GZ_{q}, BZₛ) corresponding to each set of the three target stimulus values NWXn, NWYn, NWZn, and stores them into the storage unit 148.

At the step 410, the adjusting unit 150, coupled to the source driver 106, after receiving a predetermined grayscale, finds out the ratio of three primary colors corresponding to the set of three target stimulus values fitting to the predetermined grayscale from the lookup table 152, and then transmits a compensation value based on the ratios of three primary colors to the source driver 106.

At the step 412, the source driver 106, according to the ratios of three primary colors corresponding to the set of three target stimulus values fitting to the predetermined grayscale, adjusts a driving voltage applied to multiple sub-pixels 120 of each pixel 130. When the display 100 working and the pixel 130 performing as white at the 80 grayscale, the adjusting unit 150 receives a grayscale signal of 80 grayscale, and subsequently finds out from the lookup table (LUT) 152 the ratios of primary colors (RXₚ, GX_{q}, BXₛ), (RYₚ, GY_{q}, BYₛ), (RZₚ, GZ_{q}, BZₛ) corresponding to the set of target stimulus values (NWX₈₀, NWY₈₀, NWZ₈₀), and accordingly transmits a compensation value, whereby the sub-pixel of RGB 120 of the pixel 130 automatically adjusts the ratios of three primary colors so as to perform white of the same hue as the white of grayscale 255.

In conclusion, the device, method and display of color adjustment according to the present invention ensure all whites of total grayscales performed by the display to be in the same hue. As a result, a specific color, which is performed according to each and every grayscale, remains in the same hue in human's perception. The problem of color cast according to the prior art is overcome.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A method for adjusting color, characterized in that: the method comprises:
measuring a set of tristimulus values performing as white at a first grayscale on a liquid crystal display (LCD) panel according to a first color space;
converting the set of tristimulus values into a luminance value L*₂₅₅, a first chromaticity value a*₂₅₅ and a second chromaticity value b*₂₅₅ in accordance with a second color space;
determining, based on the luminance value L*₂₅₅, the first chromaticity value a*₂₅₅ and the second chromaticity value b*₂₅₅, a target luminance value L* n of each grayscale based on the formula: L*ₙ=L*₂₅₅×(n/255)^{2.2}, a target first chromaticity value a, of each grayscale based on the formula: a*ₙ=(a*₂₅₅/255)×n, and a target second chromaticity value b*ₙ of each grayscale based on the formula: b*ₙ=(b*₂₅₅/255)×n, where n=1, 2, . . . , 255;
converting the luminance value, the first chromaticity value and the second chromaticity value of each grayscale into a plurality of sets of target values in accordance with the first color space, each grayscale corresponds to a set of target stimulus values and each set of target stimulus values comprises three target stimulus values; and
determining a set of ratios of three primary colors corresponding to each set of the three target stimulus values.

2. The method for adjusting color of claim 1, characterized in that: The method further comprises:
adjusting a set of ratios of three primary colors of a predetermined grayscale based on the set of ratios of three primary colors out of the set of three target stimulus values corresponding to the predetermined grayscale, before the LCD panel showing the predetermined grayscale.

3. The method for adjusting color of claim 2, the LCD panel comprising a plurality of pixels, each pixel comprising a plurality of sub-pixels for displaying red, green, and blue, characterized in that the method further comprises:
adjust a driving voltage applied in the plurality of sub-pixels of each pixel according to the set of ratios of three primary colors of the set of three target stimulus values corresponding to the predetermined grayscale.

4. The method for adjusting color of claim 1 characterized in that: the first color space accords with the CIE 1931 XYZ color space, and the second color space accords with the CIE 1976 L* a* b* color space.

5. A color adjustment device characterized in that the color adjustment device comprises:
a measuring unit for measuring a set of tristimulus values performing as white of the first grayscale according to the first color space on a LCD panel;
a first conversion unit, coupled to the measuring unit, for converting the tristimulus values into a set of a luminance value L*₂₅₅, a first chromaticity value a*₂₅₅, and a second chromaticity value b*₂₅₅ on the basis of the second color space;
a determining unit, coupled to the first conversion unit, for determining a target luminance value L*ₙ of each grayscale based on the formula: L*ₙ=L*₂₅₅×(n/255)^{2.2}, a target first chromaticity value a of each grayscale based on the formula: a*ₙ=(a*₂₅₅/255)×n, and a target second chromaticity value b* of each grayscale based on the formula: b*ₙ=(b*₂₅₅/255)×n, where n=1, 2, . . . , 255;
a second conversion unit, coupled to the determining unit, for converting the target luminance value, the target first chromaticity value, and the target second chromaticity value of each grayscale into a plurality of sets of target values in accordance with the first color space, where each grayscale corresponds to a set of target stimulus values, and each set of the target stimulus values comprises three target stimulus values; and
a calculation unit, coupled to the second conversion unit, for calculating a set of ratios of three primary colors corresponding to the three stimulus values of each set of the target stimulus values.

6. The color adjustment device of claim 5, characterized in that: the color adjustment device further comprises:
a storage unit for storing as a lookup table of the ratios of three primary colors corresponding to the three target stimulus values of each set of target stimulus values produced by the calculation unit.

7. The color adjustment device of claim 6, characterized in that: the color adjustment device further comprises:
an adjusting unit, coupled to the storage unit, for adjusting a set of ratios of three primary colors of the predetermined grayscale according to the ratio of three primary colors of the set of three target stimulus values corresponding to the predetermined grayscale before the LCD panel displaying a predetermined grayscale.

8. The color adjustment device of claim 5, characterized in that: the first color space accords with the CIE 1931 XYZ color space, and the second color space accords with the CIE 1976 L* a* b color space.

9. A display comprising a liquid crystal display (LCD) panel, the LCD panel comprising a plurality of pixels for displaying an image, each pixel comprising a plurality of sub-pixels, characterized in that: the display further comprises a color adjustment device, the color adjustment device comprising:
a measuring unit for measuring a set of tristimulus values performing as white of the first grayscale according to the first color space on a LCD panel;
a first conversion unit, coupled to the measuring unit, for converting the tristimulus values into a set of a luminance value L*₂₅₅, a first chromaticity value a*₂₅₅, and a second chromaticity value b*₂₅₅ on the basis of the second color space;
a determining unit, coupled to the first conversion unit, for determining a target luminance value L*ₙ of each grayscale based on the formula: L*ₙ=L*₂₅₅×(n/255)^{2.2}, a target first chromaticity value a*ₙ of each grayscale based on the formula: a*ₙ=(a*₂₅₅/255)×n, and a target second chromaticity value b*ₙ of each grayscale based on the formula: b*ₙ=(b*₂₅₅/255)×n, where n=1, 2, . . . , 255;
a second conversion unit, coupled to the determining unit, for converting the target luminance value, the target first chromaticity value, and the target second chromaticity value of each grayscale into a plurality of sets of target values in accordance with the first color space, where each grayscale corresponds to a set of target stimulus values, and each set of the target stimulus values comprises three target stimulus values; and
a calculation unit, coupled to the second conversion unit, for calculating a set of ratios of three primary colors corresponding to the three stimulus values of each set of the target stimulus values.

10. The display of claim 9, characterized in that: the color adjustment device further comprises a storage unit for storing as a lookup table of the ratios of three primary colors corresponding to the three target stimulus values of each set of target stimulus values produced by the calculation unit.

11. The display of claim 9, characterized in that: the color adjustment device further comprises an adjusting unit, coupled to the storage unit, for adjusting a set of ratios of three primary colors of the predetermined grayscale according to the ratio of three primary colors of the set of three target stimulus values corresponding to the predetermined grayscale before the LCD panel displaying a predetermined grayscale.

12. The display of claim 11, characterized in that: the display further comprises a driving unit coupled to the adjusting unit for adjusting driving voltage applied to the plurality of sub-pixels of each pixel according to the ratios of three primary colors corresponding to the set of three target stimulus values fitting to the predetermined grayscale.

13. The display of claim 9, characterized in that: the first color space accords with the CIE 1931 XYZ color space, and the second color space accords with the CIE 1976 L* a* b* color space.
